(19) United States
(12) Patent Application Publication
(10) Pub. No.: US 2016/0283719 A1
(43) Pub. Date: Sep. 29, 2016

(54) METHOD FOR EVALUATION, COMPUTER-READABLE RECORDING MEDIUM HAVING STORED THEREIN PROGRAM FOR EVALUATION, AND EVALUATOR

(71) Applicant: FUJITSU LIMITED, Kawasaki-shi (JP)

(72) Inventors: Takeaki Terada, Kawasaki (JP); Hiroshi Tsuda, Fujisawa (JP); Yoshinori Katayama, Kawasaki (JP)

(73) Assignee: FUJITSU LIMITED, Kawasaki-shi (JP)

(21) Appl. No.: 15/054,901

(22) Filed: Feb. 26, 2016

(30) Foreign Application Priority Data
Mar. 26, 2015 (JP) 2015-063803

(51) Int. Cl. G06F 21/57

(52) U.S. Cl. CPC G06F 21/577; G06F 2221/034

(57) ABSTRACT

According to an aspect of the embodiments, a method for evaluation of selection for an edited field, including: displaying information having one or more fields having undergone an editing process among multiple fields including a subject and/or a body, and a sender; accepting selection for one or more fields among the multiple fields; and outputting a result of evaluation representing a state of matching the selected fields with the fields having undergone the editing process. This makes it possible to evaluate whether the user correctly selects a field having undergone the editing process.

### CROSS-REFERENCE TO RELATED APPLICATION

This application is based upon and claims the benefit of priority of the prior Japanese Application No. 2015-63803 filed on Mar. 26, 2015 in Japan, the entire contents of which are hereby incorporated by reference.

### FIELD

The embodiments discussed herein are related to a method for evaluation, a computer-readable recording medium having stored therein a program for evaluation, and an evaluator.

### BACKGROUND

A social issue of “targeted cyber attacks” has arisen which attacks a targeted cooperation with the view of confidential information fraud or system corruption. E-mails (hereinafter simply called “mails”) are main means to intrude into the Information Technology (IT) system of a target corporation. A mail used for system intrusion is called a “targeted mail” in distinction from a typical spam mail targeted at unspecified people.

Since a conventional anti-virus program and a spam filter are incapable of dealing with a targeted mail, a countermeasure by the user side (e.g., each employee) is of quite importance. In view of the above, a technique is provided which sends a dummy mail simulating a target mail and containing a factitious body and subject and also an attached file to each user and records, if the user opens the attached file, the incident.

[Patent Literature 1] Japanese Laid Open Patent Publication No. 2013-149063

However, the above technique has a difficulty in detecting which field (e.g., header information, the body, or the attached file) of the dummy mail has made the user impress that the mail is suspicious and refrain from opening the attached file or which fictitious field the user has missed to open the attached file.

### SUMMARY

According to an aspect of the embodiments, a method for evaluation of selection for an edited field, including: displaying information having one or more fields having undergone an editing process among multiple fields including a subject and/or a body, and a sender; accepting selection for one or more fields among the multiple fields; and outputting a result of evaluation representing a state of matching the selected fields with the fields having undergone the editing process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of the hardware configuration of an evaluator;

FIG. 2 is a diagram illustrating an example of a training screen;

FIG. 3 is a flow diagram denoting a succession of procedural steps of evaluating selection in an evaluator according to a first embodiment;

FIG. 4 is a diagram illustrating a succession of procedural steps of generating a training screen by an evaluator according to a second embodiment;

FIG. 5 is a diagram illustrating an example of a screen of displaying evaluation result information;

FIG. 6 is a flow diagram denoting a succession of procedural steps of evaluating selection in an evaluator of the second embodiment;

FIG. 7 is a diagram illustrating an example of the connection between an evaluator and a communication network;

FIG. 8A is a diagram illustrating an example of a received mail;

FIG. 8B is a diagram illustrating an example of a training screen generated on the basis of the received mail of FIG. 8A;

FIG. 9 is a diagram illustrating an example of a generation standard table;

FIG. 10 is a flow diagram denoting a succession of procedural steps of evaluating selection by the evaluator according to a third embodiment; and

FIG. 11 is a diagram illustrating an example of a screen of displaying the result of evaluation.

### DESCRIPTION OF THE PREFERRED EMBODIMENTS

Hereinafter, description will be made in relation to embodiments with reference to the accompanying drawings. The processes of the embodiments can be appropriately combined. Like reference numbers in all the drawings designate the same or substantially same parts and elements, so repetitious description is omitted here.

### First Embodiment

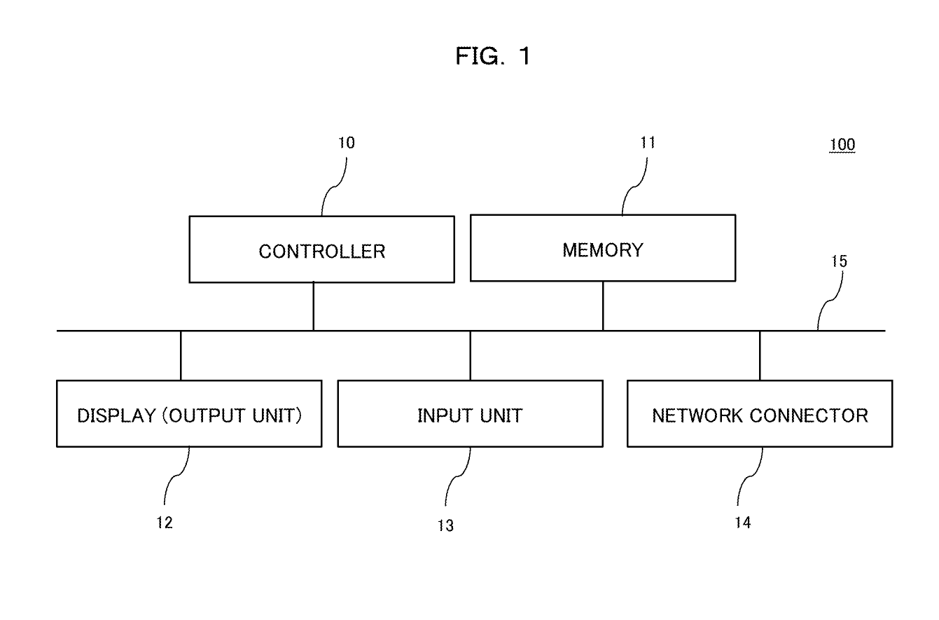

Description will now be made in relation to an example of the hardware configuration of an evaluator 100 by referring to FIG. 1. FIG. 1 is a diagram illustrating an example of the hardware configuration of the evaluator 100. An example of the evaluator 100 is an information processor such as a Personal Computer (PC), a tablet terminal, or a smartphone. In the evaluator 100, a program (for example, in the form of an application or software) for evaluation of the first embodiment is installed. The evaluator 100 executes the following method for evaluation using the installed program for evaluation.

The evaluator 100 includes a controller 10, a memory 11, a display (output unit) 12, an input unit 13, and a network connector 14, which are connected to one another via a system bus 15. The controller 10 is a device that controls the evaluator 100. The controller 10 may be an electronic circuit such as a Central Processing Unit (CPU) or a Micro Processing Unit (MPU). The controller 10 controls processes of the evaluator, such as various calculation and data input/output with each hardware device on the basis of the control program such as an Operating System (OS) and an execution program stored in the memory 11. Various pieces of information to be used in the execution of such programs can be obtained from, for example, the memory 11. The controller 10 achieves various processes by reading the program for evaluation that defines various processes stored in the memory 11 and executing the read program for evaluation. Alternatively, each process may be achieved by dedicated hardware.

The memory 11 may include a main memory and an auxiliary memory. The main memory temporarily stores therein at least part of the OS and an application program to be executed by the controller 10. Furthermore, the main memory stores therein various pieces of data to be used in process performed by the controller 10. Examples of the main memory is a Read Only Memory (ROM) and Random Access Memory (RAM).

The auxiliary memory stores therein, for example, the execution program of each embodiment and a control program provided for the computer. The auxiliary memory can read various pieces of information and write information in response to a control signal from the controller 10. Examples of the auxiliary memory is a Hard Disk Drive (HDD) and a Solid State Drive (SSD). The auxiliary memory may store therein information to be used in the process of each embodiment. The main memory and the auxiliary memory may cover their functions of each other.

The display 12 includes a display monitor that displays information and data to be used for an editing process performed by the evaluator of each embodiment and displays the progression of the program for evaluation and the result of evaluation in response to a control signal from the controller 10.

The input unit 13 receives an instruction to execute a program, pieces of information relating to various editing processes, and information to start software that are input (from, for example, the user of the evaluator 100). The input unit 13 includes pointing devices such as a keyboard and a mouse with which the user of the evaluator 100 carries out an editing process. The display 12 and the input unit 13 may take an integrated form such as a touch-panel display.

The network connector 14 connects to the communication network in response to a control signal from the controller 10 and thereby communicates with, for example, a server. The network connector 14 can obtain the execution program, an application, software, setting information, and other data from an external device connected to the communication network. The network connector 14 can provide a result of evaluation obtained through the execution of the program for evaluation and the program for evaluation of each embodiment to, for example, an external device.

The above hardware configuration makes each embodiment to execute the corresponding evaluation. Each embodiment installs a program for evaluation that causes a computer, such as a versatile PC, to execute each function and consequently can execute evaluation according to the embodiment in cooperation between the hardware resource and the software resource.

Hereinafter, description will now be made in relation to each process performed by the controller 10 of the evaluator 100 in the execution of the program for evaluation of the method for evaluation and the program for the evaluation according to the first embodiment.

The controller 10 displays a message consisting of multiple fields on the display 12. Examples of the fields are the subject and/or the body, and the sender of the message. The fields are not limited to these examples and any additional fields can be suggested. A message to be displayed has undergone a particular editing process on at least one or more of the fields. Such a particular editing process may be made by a third party including another user, another computer, or the controller 10 (or an external device).

The message may be of a mail format or a simple message form. The description below assumes that a message is of a mail format and that the editing process is exemplified by a process of generating a simulated targeted mail. However, the message and the process are not limited to these assumptions.

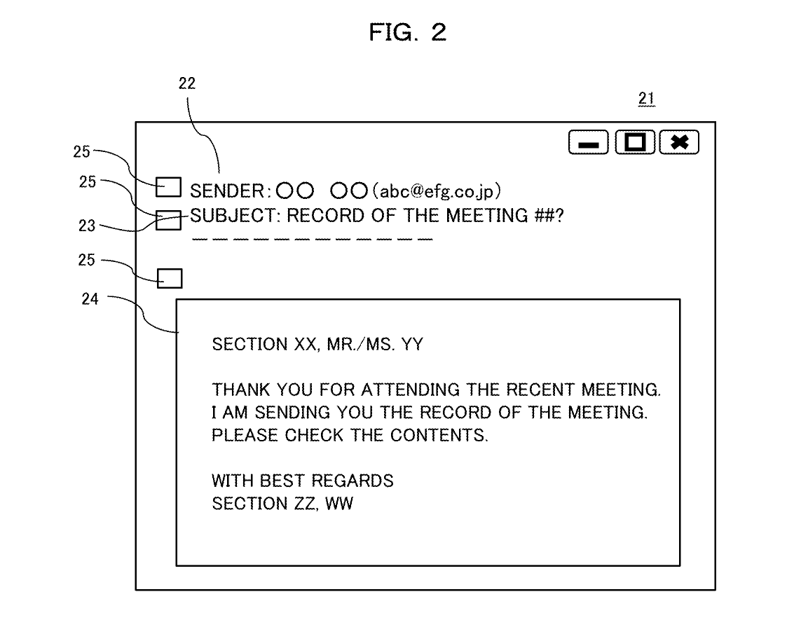

FIG. 2 illustrates an example of the contents (e.g., training screen 21) of a simulated targeted mail that is stored in the memory 11 and is read and displayed by the controller 10.

The training screen 21 includes, for example, the fields of a sender 22, a subject 23, and/or a body 24 and may include an additional field. The sender 22, which represents the sender of the message, is not limited to information of the sender person and may alternatively be a user name, a sender computer name, a virtual person, or a virtual computer name.

The contents of a particular field among the fields included in the training screen 21 has been subjected to an editing process to include a suggestion to simulate a targeted mail. A “suggestion” here makes the user feel quite abnormal at a glance and is exemplified by a wrong Chinese character notation, a lack of a necessary letter or symbol, and an addition of an unnecessary letter or symbol (see the subject 23 of FIG. 2). However, the suggestion is not limited to the above examples.

The training screen 21 further includes selection objects (e.g., checkboxes 25) provided one for each field to accept selection made for each field. A checkbox 25 may be arranged at the leading position of the corresponding field, or multiple check boxes 25 provided one for each corresponding field may be arranged at a predetermined position (e.g., at the top or bottom of the training screen 21) in a lump. Further alternatively, with respect to the field of the body 24, a checkbox 25 may be provided for each line to accept selection.

The training screen 21 satisfactorily have a function of accepting selection and a checkbox 25 may be replaced with a radio button provided for each field or a selection button which causes the corresponding field to take the form of a button. Further alternatively, the checkboxes 25 may be replaced with an input field into which the number or name of a selected field is to be input.

When the user makes a selection on the screen, the controller 10 accepts a selection for each field via the input unit 13. For example, when the user selects the subject 23 (for example, by inputting a check into the checkbox 25 provided for the subject 23), the controller 10 accepts the selection for the subject 23. Namely, the controller 10 functions as a receiver that accepts the selection for one or more fields among the multiple fields.

Then, the controller 10 outputs, on the display (output unit) 12, the result of evaluation representing a state of matching a field for which the selection is accepted with a field having undergone the editing process to include the above suggestion. Specifically, when selection for a field that has not undergone the editing process to include the suggestion is accepted, the controller 10 outputs the result of evaluation representing that the selection is incorrect. In contrast, when selection for a field that has undergone the editing process to include the suggestion is accepted, the controller 10 may output the result of evaluation representing that the selection is correct. Furthermore, when selection for a field that has undergone the editing process to include the suggestion is not accepted, the controller 10 may output the result of evaluation representing the presence of selecting omission. Further alternatively, the controller 10 may output the result of evaluation representing a matching, such as 10% of matching, which means the extent of matching fields for which selection is accepted with fields that have undergone the editing process.

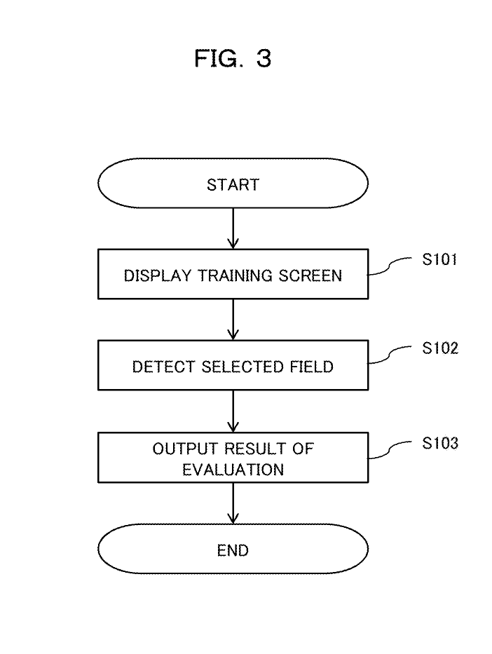

Next, description will now be made in relation to a flow of the process of the method for evaluation in the evaluator 100 of the first embodiment with reference to FIG. 3. FIG. 3 illustrates a succession of procedural steps of evaluating selection in the evaluator 100 of the first embodiment.

The controller 10 displays a training screen 21 on the display 12 (S101). When the user makes selection on the screen, the input unit 13 notifies the controller 10 of the contents of the selection and the controller 10 responsively detects the field selected by the user (S102). Next, the controller 10 outputs the result of evaluation representing the state of matching each field for which the selection is accepted with the field having undergone an editing process including a suggestion (S103).

In the first embodiment, the user makes selection for a field that the user presumes to include a suggestion and then can recognize, on the basis of the result of evaluating each selected field, whether the user's selection for each field is correct or incorrect. Further, the user can confirm which field the user did not made correct judgment from the result of evaluation and consequently can improve his/her opposition to targeted mails. Consequently, the evaluator 100 of the first embodiments provides a user with training for dealing with targeted mails.

The evaluator 100 may manage the start of the program for evaluation on the basis of a predetermined schedule, display a training screen 21 at regular intervals to provide training for dealing with targeted mails. In this case, the evaluator 100 may display a training screen 21 free from a suggestion for all the fields at a predetermined probability (e.g., once out of five times). Here, the probability may be set by the user through the input unit 13. This causes the user to pay more attention to the training screen 21 in making selection, which enhances the efficiency of the training.

### Second Embodiment

Hereinafter, description will now be made in relation to a second embodiment. To accomplish the method for evaluation and the program for evaluation according to the second embodiment, the controller 10 of the evaluator 100 carries out a process of generating a training screen 21 and a process of evaluating a user's selection as will be detailed below in addition to the processes carried out in the method for evaluation and the program for evaluation according to the first embodiment.

The controller 10 generates a training screen 21 simulating a target mail on the basis of a template stored in the memory 11. A template here is data that defines the contents of a message including multiple fields, the contents being to be displayed. The memory 11 may include multiple templates. In generating a training screen 21, the controller 10 carries out an editing process that includes a suggestion into one or more particular fields (e.g., the subject, the body, the sender, and arbitrary combinations thereof) among the fields of the training screen 21. The controller 10 stores identifying information of each field having been subjected to the editing process and the contents of the editing process in association with each other.

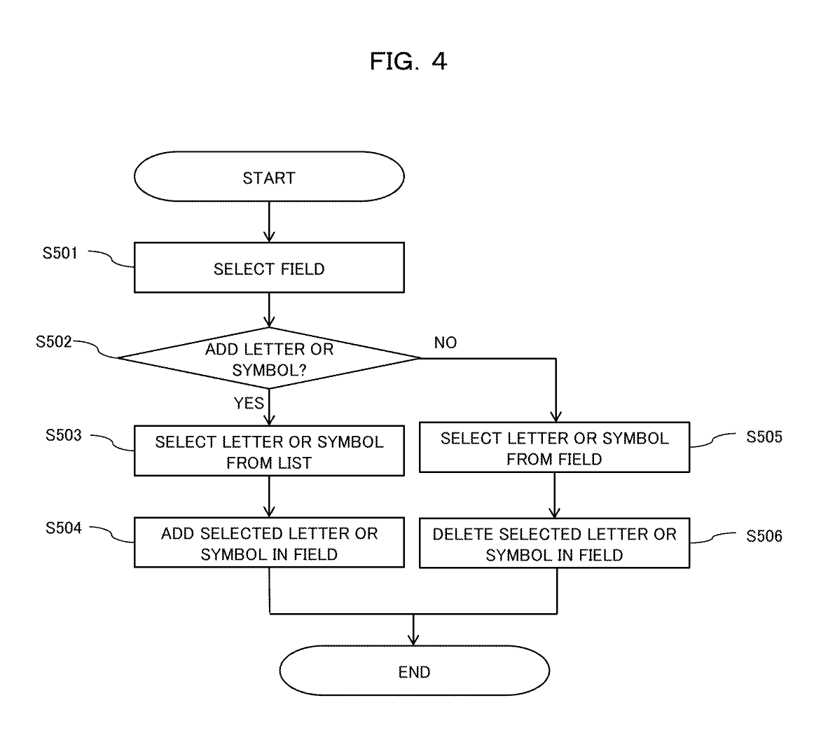

FIG. 4 is a diagram illustrating a succession of procedural steps of generating a training screen by the evaluator of the second embodiment. Description will now be made in relation to a flow of generating a training screen 21 by the controller 10 with reference to FIG. 4. First of all, the controller 10 reads, if the memory 11 stores therein a single template, the template or reads, if the memory 11 stores therein multiple templates, one of the templates. Then the controller 10 selects a field that is to undergo an editing process to include a suggestion by following a predetermined algorithm (S501).

The predetermined algorithm may select a field determined by a random number or may switch the field to be selected in predetermined rotation each time a training screen is generated.

Next, the controller 10 adds a letter or a symbol that is to serve as the suggestion to the selected field in the template (S502). The controller 10 determines whether a letter or a symbol is to be added as a suggestion to the selected field of the template. If a letter or a symbol is to be added (Yes route in S502), the controller 10 selects one or more letters and/or symbols from a letter-and-symbol list (S503), and add the selected letters and/or symbols to somewhere in the selected field (S504).

If a letter or a symbols is not to be added (No route in S502), the controller 10 selects one or more letters and/or symbols from the selected field (S505) and deletes or converts the selected letters and/or symbols from or in the field (S506). Alternatively, the controller 10 may make no process of, for example, deletion or conversion on the selected symbols and/or letters in the process of S506.

Furthermore, the controller 10 determines a state of matching the fields for which the selection is accepted via the input unit 13 with the fields having undergone the editing process to include the suggestion. For example, upon receipt of an instruction from the user, the controller 10 refers to the memory 11 in which identification information of the fields having undergone the editing process to include a suggestion is stored, and determines whether a field having undergone the editing process to include a suggestion matches or does not match with any of fields for which selection is accepted via the input unit 13 in a unit of a field. The manner of the determination is not limited to the above, and alternatively, the controller 10 may determine whether only the fields having undergone the editing process to include a suggestion matches or does not match any of the selected field.

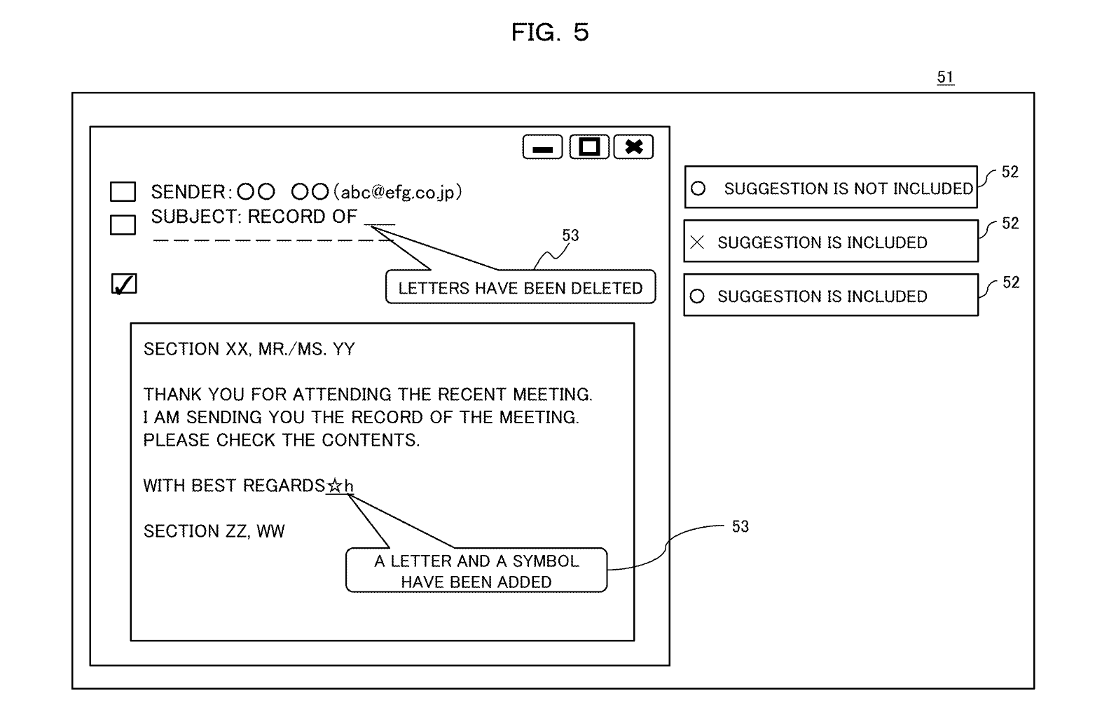

The controller 10 further generates information of the result of evaluation of selection on the basis of the result of the determination. FIG. 5 illustrates an example of a displaying screen 51 of the evaluation result information generated by the controller 10. The controller 10 may generate the evaluation result information by adding information 52 representing correct/incorrect selection and information 53 explicating a suggestion included in a training screen 21 to the displayed form the same training screen 21 on which the user has made selection. Here, the evaluation result information may be stored in the memory 11.

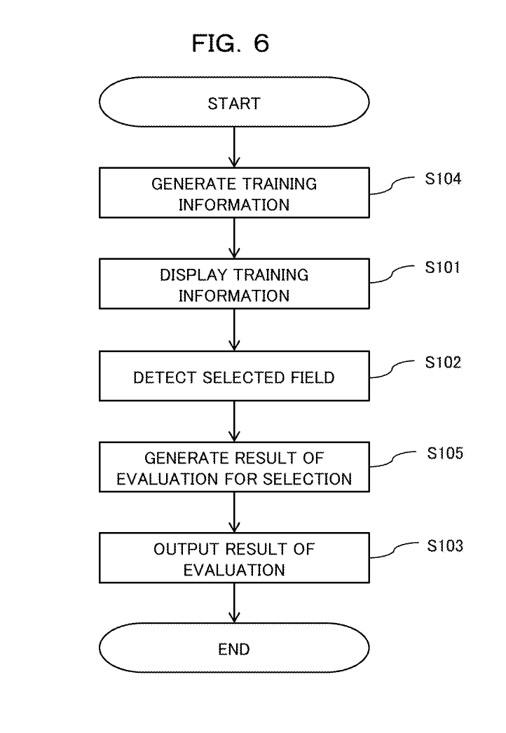

Next, description will now be made in relation to a flow of the method of evaluation of the evaluator 100 of the second embodiment with reference to FIG. 6. FIG. 6 illustrates a succession of procedural steps of evaluation of selection in the evaluator 100 of the second embodiment.

When the user issues an instruction or when the scheduled date and time come, the controller 10 starts the process. At first, the controller 10 generates a training screen 21 based on a template stored in the memory 11 (S104). The controller 10 displays the training screen 21 on the display 12 (S101). Then, when the user makes selection on the screen, the input unit 13 notifies the details of the selection to the controller 10, which detects the selected field (S102). The controller 10 determines a state of matching a field for which selection is accepted with a field having undergone the editing process including the suggestion, and generates the evaluation result information of the selection on the basis of the determined state of matching (S105). Next, the controller 10 outputs the result of evaluation to the display 12 (S103).

Along the above procedure, the evaluator 100 of the second embodiment trains a user for dealing with targeted mails. The second embodiment, which displays the result of evaluation with information to the user, can enhance the training efficiency for dealing with targeted mails by providing feedback.

Here, the controller 10 can carry out the editing process on a received mail. Specifically, the controller 10 may obtain a received mail and carry out the editing process on one or more of the fields included in the received mail to generate a training screen, which will be displayed. Further alternatively, the controller 10 does not display such a training screen immediately after the editing process is carried out, but may store the received mail having undergone the editing process and display the mail when user tries to open the mail.

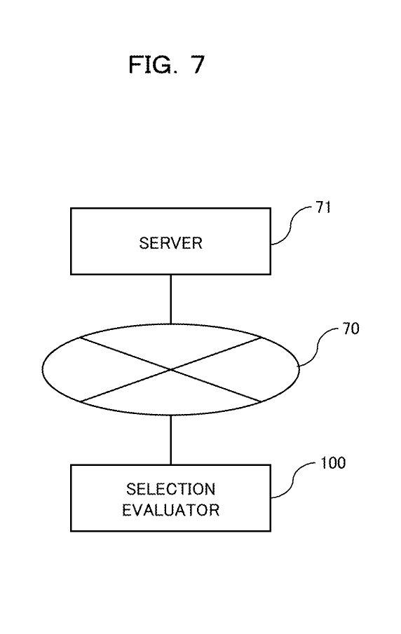

FIG. 7 illustrates an example of connection between the evaluator 100 and the communication network. As illustrated in FIG. 7, the evaluator 100 is connected to a server 71, under a state of being capable of transmitting and receiving data via a communication network 70, such as Internet or a Local Area Network (LAN). The connection is not limited to a case where a single evaluator 100 is not connected to the server 71, and alternatively, multiple evaluators 100 may be connected to the server 71.

If the server 71 has the function of a mail server, the evaluator 100 may store a received mail into the memory 11 and generate a training screen 21 on the basis of the information of the received mail. Specifically, the controller 10 extracts the described contents from each field of a received mail stored in the memory 11 and generates a training screen 21 using the extracted contents. At this time, the controller 10 carries out an editing process to include a suggestion in the particular one or more fields.

The controller 10 may generate a training screen 21 on the basis of information of multiple received mail. In this case, the controller 10 may extract a described content of a field from a first received mail and extract the described contents of the remaining fields from a second received mail.

Further alternatively, the controller 10 may embed the extracted contents to the fields of the template of the training screen 21 or may store the training screen 21 having undergone the editing process, which will be regarded as a mail, in the receiving box in the mailer. In this case, when the user opens training screen 21 in the receiving box, the training screen 21 having a selective object for each field is displayed.

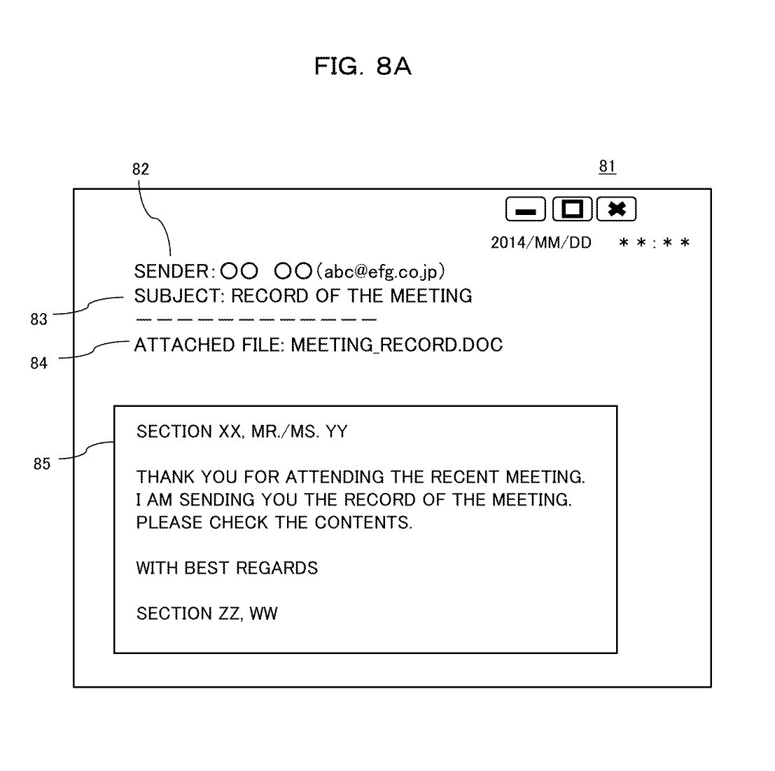

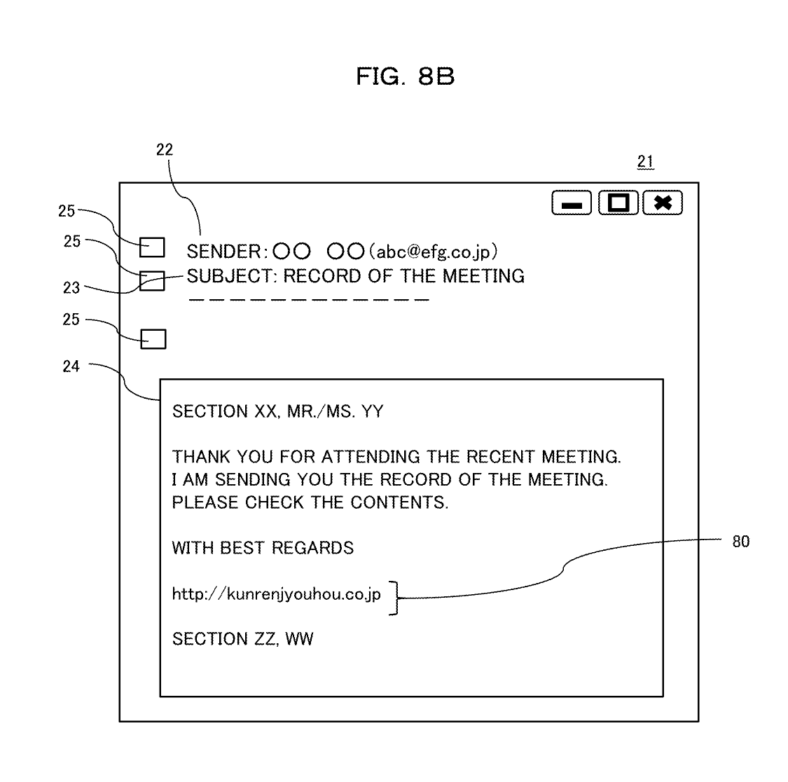

FIG. 8A illustrates an example of a received mail 81. The received mail 81 includes, for example, the fields of a sender 82, a subject 83, an attached file 84, and a body 85. FIG. 8B illustrates an example of a training screen 21 generated on the basis of the received mail 81 of FIG. 8A. More specifically, as illustrated in FIGS. 8A and 8B, the controller 10 generates a training screen 21 by adding, as a suggestion, a Uniform Resource Locator (URL) 80, which the received mail 81 does not have, to the field of the body 85 of the received mail 81, and providing a checkbox 25 to each field. The subsequent process is the same as the second embodiment.

The controller 10 may carry out the editing process, displaying of a training screen including a field subjected to the editing process, storing of the training screen subjected to the editing process as a mail within a predetermined time period or after the lapse of a predetermined time period from the reception of the mail, or when predetermined time comes. When the training screen is displayed within a predetermined time period from the reception of the mail, there is a high possibility that the user remembers the contents of the received mail and easily finds the field having undergone the editing process, so that the time point is optimum for beginners. In contrast, when the training screen is displayed after the lapse of a predetermined time period, there is a low possibility that the user remembers the contents of the received mail and the user has more difficulty in finding the field subjected to the editing process. This can eliminate a problem of failing in evaluating a well-trained user because the selection for fields is too easy. The displaying when the predetermined time comes can be used in, for example, regular training.

In this example, since a training screen 21 is generated on the basis of a mail received by a user, the evaluator 100 can train the user using the training screen 21 based on the history of the user's mail. This allows the user to be trained by using the training screen 21 closer to a real targeted mail, which can enhance the efficiency of the training.

Alternatively, the server 71 may generate a training screen 21 and evaluate the selection in place of the evaluator 100. In this case, the server 71 generates a training screen 21 and then transmits screen information of the generated training screen 21 to the evaluator 100. The evaluator 100 displays the training screen 21 based on the received screen information and accepts selection. The evaluator 100 transmits information of each field for which selection has been accepted to the server 71, which then determines the state of matching the field for which the selection is accepted with the field having undergone an editing process including a suggestion, generates evaluation result information of the selection, and transmits the evaluation result information to the evaluator 100. The above alternative in which the server 71 generates a training screen 21 and evaluates a selection also allows the evaluator 100 to evaluate the selection. In particular, this alternative can reduce the processing load on the evaluator 100.

Further, the server 71 may manage the schedule of the training conducted by the evaluator 100. Specifically, the evaluator 100 may execute the process defined in the method of evaluation on the basis of notification information from the server 71, and may consequently evaluate the selection. This allows a third party such as a manager to instruct multiple evaluators 100 to start the training all at once.

Further alternatively, the server 71 may collect evaluation results from the evaluator 100 to construct a database for various analyses. Each time the training is conducted, the server 71 may receive the result of evaluation of the selection from the evaluator 100 and may store and accumulate the result of evaluation. Here, an result of evaluation of the selection includes, for example, a user's learning level, the number of correct selections, and the number of incorrect selections, but is not limited to those examples. The accumulated results stored in the server 71 can be used by a third party such as a manager of a company for grasping opposition to targeted mails for each employee or each department in the company.

### Third Embodiment

Hereinafter, description will now be made in relation to a third embodiment. To accomplish the method for evaluation and the program for evaluation according to the third embodiment, the controller 10 of the evaluator 100 carries out a process of generating a training screen 21 according to a learning level and a process of calculating a learning level as will be detailed below in addition to the processes carried out in the method for evaluation and the program for evaluation according to the second embodiment.

Here, a learning level of a user represents a level of user's achievement in training of this embodiment, which is converted into a number. The learning level is an example of a parameter. The controller 10 calculates the learning level of a user on the basis of the result of evaluation of the selection made by the same user. For example, the controller 10 calculates the number (learning level) related to the number of correct selection and the number of incorrect selection for each evaluation. When the user makes many correct selections and a few incorrect selections, the controller 10 calculates a higher learning level; while when the user makes a few correct selections and many incorrect selections, the controller 10 calculates a lower learning level.

A generation standard here defines a field that is to include a suggestion and the extent of the suggestion on a training screen 21 to be generated. The generation standard and the learning level of each user are stored in the memory 11. The controller 10 obtains the learning level of the user by referring to the memory 11 and generates the training screen 21 on the basis of the obtained learning level.

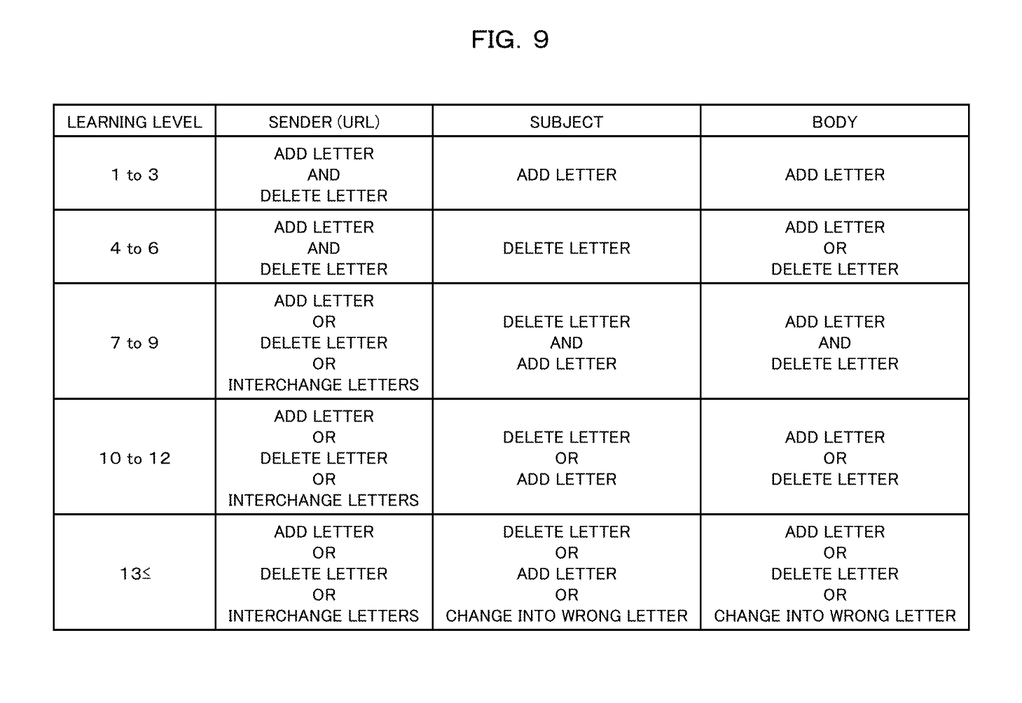

FIG. 9 is a diagram illustrating an example of a generation standard table. As illustrated in FIG. 9, defining the generation standard for each learning level, the evaluator 100 can provide a training screen 21 according to the learning level of a user.

Specifically, in cases where the learning level of a user is four and a subject is selected as a field to undergo the editing process among the multiple fields, the controller 10 refers to the generation standard table stored in the memory 11 and obtains the details of the editing process of deleting a letter. Then the controller 10 performs the editing process on the contents of the field of the subject on the basis of the corresponding editing details and thereby generates a training screen 21.

Furthermore, the controller 10 calculates the learning level of each user on the basis of the result of evaluation of the selection. Such a calculated learning level is stored in the memory 11 to be a new learning level. For example, a learning level is calculated along the expression of: learning level=previous learning level+1−a(the number of fields missed)−b(the number of fields incorrectly selected). Here, the symbols a and b are coefficients and can be set to be any numbers. For example, a and b may be set to be 0.5 and 1, respectively, but are not be limited to this. A lowest value (e.g., 1) of the learning level is set for a user that has never trained.

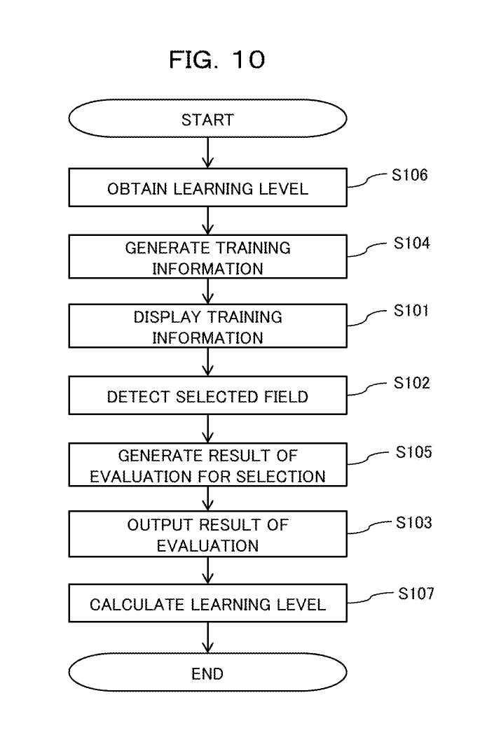

Next, description will now be made in relation to a flow of the method for evaluation by the evaluator 100 of the third embodiment by referring to FIG. 10. FIG. 10 illustrates a succession of procedural steps of evaluating the selection in the evaluator 100 of the third embodiment.

The controller 10 starts the process when the controller 10 receives an instruction from a user or when the scheduled time comes. First of all, the controller 10 obtains the learning level of the user from the memory 11 (S106). Next, the controller 10 refers to the generation standard table to specify the generation standard according to the obtained learning level and generates the training screen 21 on the basis of the specified generation standard (S104). Then, the controller 10 displays the generated training screen 21 on the display 12 (S101). When the user makes a selection on the screen, the input unit 13 notifies the controller 10 of the contents of the selection and the controller 10 responsively detects the field selected by the user (S102). The controller 10 determines matching of a field for which selection is accepted with a field having undergone the editing process to include the suggestion, and generates the evaluation result information of the selection on the basis of the state of the determined matching (S105). Next, the controller 10 outputs the result of evaluation to the display 12 (S103). Furthermore, the controller 10 calculates the learning level based on the result of evaluation (S107). The calculated learning level is stored into the memory 11 to be the new learning level.

The evaluator 100 of the third embodiment updates the learning level of a user on the basis of the result of training and generates a training screen according to the updated learning level, so that training having a difficulty matched for the learning level of each user can be conducted.

Alternatively, the controller 10 of the evaluator 100 of the third embodiment may generate a training screen 21 by referring to results of previous evaluation. For example, the controller 10 refers to result of evaluation history data stored in the memory 11 to specify a field that the user erroneously selected or the details of the editing process that the user erroneously selected, and consequently carries out the same or a different editing process on the same field or carries out the same editing process on the same or a different field.

Specifically, if the result of previous evaluation indicates that the user had made an incorrect selection for the field of the subject, the controller 10 may select the subject as the field that is to undergo the editing process to include a suggestion and generate a training screen 21 by adding an unnecessary letter string to the subject. Consequently, the evaluator 100 generates a training screen 21 in which a suggestion is preferentially added to a field that the user is likely to incorrectly select.

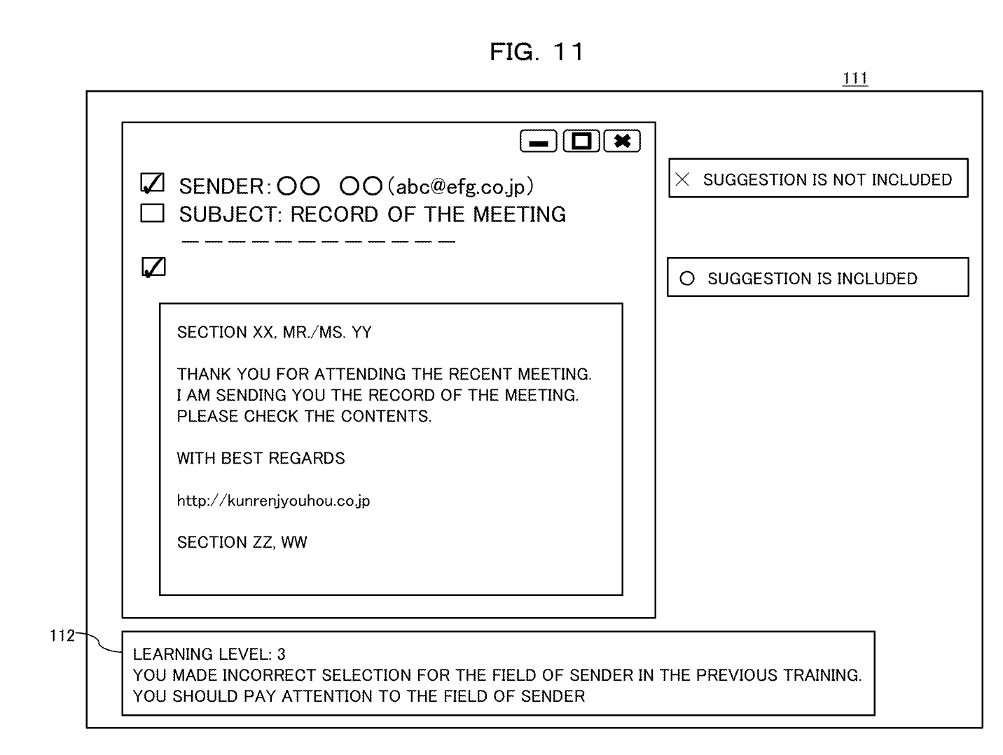

FIG. 11 illustrates an example of a displaying screen 111. As illustrated in FIG. 11, the controller 10 may generate evaluation result information including a comment field 112 indicating information, such as the calculated learning level, the result of past evaluation, and an advice. Consequently, the user can recognize his/her opposition to targeted mails via an objective value, and can grasp his/her tendency for correct or incorrect selection for each field.

The result to be output may be different between a case where the state represents perfect matching and a case where the state represents partial matching. The result to be output may include information that specifies a field not matched. The result to be output may include a degree of matching the selected fields with the fields having undergone the particular editing process. The particular editing process may be based on the parameter and the parameter may be changed with the result. The selection may be made by selecting objects associated one with each of the multiple fields.

The present invention should by no means be limited to the configuration of the above embodiments, and various changes and modification can be suggested without departing from the spirit of the present invention.

The foregoing embodiments make it possible to evaluate as to whether the user has correctly select a field that has undergone the editing process.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for evaluation of selection for an edited field, comprising:
displaying information having one or more fields having undergone an editing process among multiple fields including a subject and/or a body, and a sender;
accepting selection for one or more fields among the multiple fields; and
outputting a result of evaluation representing a state of matching the selected fields with the fields having undergone the editing process.

2. The method according to claim 1, wherein the multiple fields are fields included in a mail stored in a memory.

3. The method according to claim 1, wherein the editing process adds and/or deletes one or more letters.

4. The method according to claim 2, wherein the editing process uses information of one or more fields included in a mail different from the mail stored in the memory.

5. The method according to claim 1, wherein the result to be output is different between a case where the state represents perfect matching and a case where the state represents partial matching.

6. The method according to claim 1, wherein the result to be output includes information that specifies a field not matched.

7. The method according to claim 1, wherein the result to be output includes a degree of matching the selected fields with the fields having undergone the particular editing process.

8. The method according to claim 1, wherein the editing process is based on a parameter.

9. The method according to claim 8, wherein the parameter is changed with the result.

10. The method according to claim 1, wherein the selection is made by selecting objects associated one with each of the multiple fields.

11. A non-transitory computer readable recording medium having stored therein a program for evaluation of selection for an edited field, the program that causes a computer to execute:
displaying information having one or more fields having undergone an editing process among multiple fields including a subject and/or a body, and a sender;
accepting selection for one or more fields among the multiple fields; and
outputting a result of evaluation representing a state of matching the selected fields with the fields having undergone the editing process.

12. An estimator for estimation of selection for an edited field comprising:
a processor that executes a method including:
displaying information having one or more fields having undergone an editing process among multiple fields including a subject and/or a body, and a sender;
accepting selection for one or more fields among the multiple fields; and
outputting a result of evaluation representing a state of matching the selected fields with the fields having undergone the editing process.
